(19) United States
(12) Patent Application Publication
(10) Pub. No.: US 2017/0093930 A1
(43) Pub. Date: Mar. 30, 2017

(54) INFORMATION TRANSMISSION SYSTEM, INFORMATION TRANSMISSION METHOD, AND STORAGE MEDIUM

(71) Applicant: Hiroki OZAKI, Tokyo (JP)

(72) Inventor: Hiroki OZAKI, Tokyo (JP)

(21) Appl. No.: 15/268,971

(22) Filed: Sep. 19, 2016

(30) Foreign Application Priority Data
Sep. 25, 2015 (JP) 2015-187628

(51) Int. Cl. H04L 29/06

(52) U.S. Cl. CPC H04L 65/1066; H04L 65/403

(57) ABSTRACT

An information transmission system includes a plurality of communication terminals including at least a first terminal and a second terminal, and an information transmission apparatus to receive operation information from the plurality of communication terminals via the network and to transmit image data corresponding to the received operation information to the plurality of communication terminals via a network. The information transmission apparatus generates a transmission-use image to be transmitted to one or more of the communication terminals based on operation information and transmission allowing/not-allowing information set for the one or more of the communication terminals that are output from at least one of the communication terminals.

### CROSS-REFERENCE TO RELATED APPLICATION

This application claims priority pursuant to 35 U.S.C. §119(a) to Japanese Patent Application Nos. 2015-187628, filed on Sep. 25, 2015 in the Japan Patent Office, the disclosure of which are incorporated by reference herein in their entirety.

### BACKGROUND

Technical Field

This disclosure relates to an information transmission system having a plurality of communication terminals and an information transmission apparatus, an information transmission method in the information transmission system, and a storage medium storing a control program for performing the information transmission method.

Background Art

Information processing systems have been developed, which can transmit image data among a plurality of communication terminals via a network. Each communication terminal operates interactively with a user to generate image data, processes the image data with its information processing capability, and inputs the image data to the system for transmission. However, the image data input to the system from one communication terminal cannot be transmitted to other communication terminal selected from among the plurality of communication terminals.

### SUMMARY

As one aspect the present invention, an information transmission system is devised. The information transmission system includes a plurality of communication terminals including at least a first terminal and a second terminal, and an information transmission apparatus to receive operation information from the plurality of communication terminals via the network and to transmit image data corresponding to the received operation information to the plurality of communication terminals via a network. When the operation information is input from at least one of the communication terminals, the at least one of the communication terminal outputs the operation information and transmission allowing/not-allowing information set for each one of the plurality of communication terminals to the information transmission apparatus, the transmission allowing/not-allowing information including transmission allowing information or transmission not-allowing information indicating whether the operation information is to be transmitted to each one of the communication terminals. The information transmission apparatus generates a transmission-use image to be transmitted to one or more of the communication terminals based on the operation information and the transmission allowing/not-allowing information that are output from the at least one of the communication terminals.

As another aspect the present invention, a method of transmitting information among a plurality of communication terminals via a network is devised. The method includes acquiring an operation information input from each one of the communication terminals and transmission allowing/not-allowing information set for each one of the communication terminals, the transmission allowing/not-allowing information including transmission allowing information or transmission not-allowing information indicating whether the operation information is to be transmitted to each one of the communication terminals, generating image data to be transmitted to one or more of the communication terminals based on the acquired operation information and the transmission allowing information, and transmitting the generated image data to the one or more of the communication terminals.

As another aspect the present invention, a non-transitory storage medium storing a program that, when executed by a computer, causes the computer to execute a method of transmitting information among a plurality of communication terminals via a network is devised. The method includes acquiring an operation information input from each one of the communication terminals and transmission allowing/not-allowing information set for each one of the communication terminals, the transmission allowing/not-allowing information including transmission allowing information or transmission not-allowing information indicating whether the operation information is to be transmitted to each one of the communication terminals, generating image data to be transmitted to one or more of the communication terminals based on the acquired operation information and the transmission allowing information, and transmitting the generated image data to the one or more of the communication terminals.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram of a configuration of an information transmission system of one example embodiment of the present invention;

FIG. 2 is a block diagram of a hardware configuration of an electronic information board of FIG. 1, according to an embodiment;

FIG. 3 is a functional block diagram of the electronic information board of FIG. 1, according to an embodiment;

FIG. 4 is a functional block diagram of a communication terminal of FIG. 1, according to an embodiment;

FIG. 5 is an illustration for explaining an image data transmission method of a first example embodiment of the present invention;

FIG. 6 is a data sequence diagram performed by the electronic information board and the communication terminal, according to an embodiment;

FIG. 7 is an illustration for explaining an image data transmission method of a second example embodiment;

FIG. 8 is an illustration for explaining an image data transmission method of a third example embodiment;

FIG. 9 is a flow chart illustrating operation of a first example of a control process performed for the electronic information board;

FIG. 10 is a flow chart illustrating operation of one example control process performed for the communication terminal;

FIG. 11 is a flow chart illustrating operation of a first example of a control process performed for the electronic information board; and

FIGS. 12A and 12B are a flow chart illustrating operation of a third example of a control process performed for the electronic information board.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, one or more apparatuses or systems according to one or more example embodiments are described hereinafter.

### (Configuration of Information Transmission System)

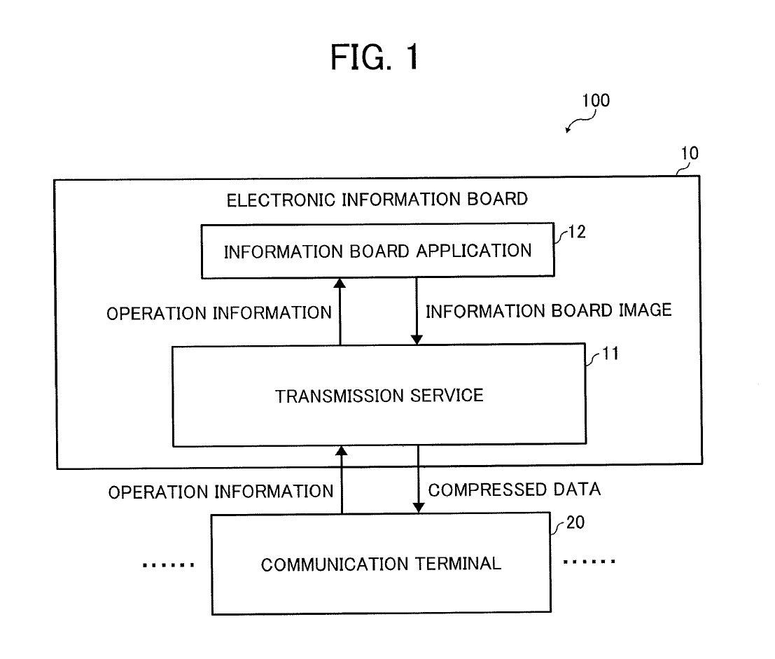

A description is given of an information transmission system 100 of one example embodiment of the present invention with reference to the drawings. FIG. 1 is a schematic diagram of a configuration of the information transmission system 100 of one example embodiment of the present invention. The information transmission system 100 can be used as an image information transmission system to transmit information such as image information among a plurality of information apparatuses.

As illustrated in FIG. 1, the information transmission system 100 includes, for example, an electronic information board 10 used as an example of an information transmission apparatus that can transmit information such as image information, and a plurality of communication terminals 20 used as an example of information apparatuses. The electronic information board 10 is, for example, an electronic white board. The information transmission system 100 can be used to transmit image information among the plurality of communication terminals 20 and the electronic information board 10.

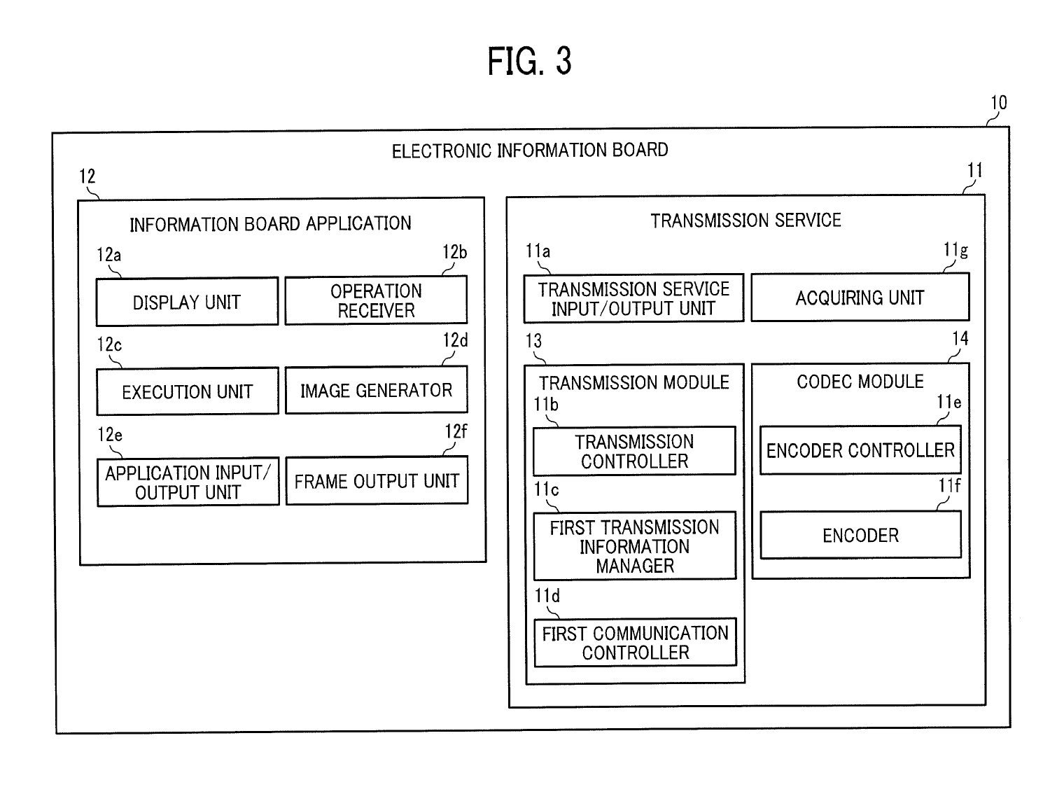

The electronic information board 10 includes, for example, a transmission service 11 and an information board application 12, each of which may be implemented by software installed onto the electronic information board 10. The transmission service 11 receives operation information from the communication terminal 20, and transmits an image to the communication terminal 20. The information board application 12 includes a display unit 12a (see FIG. 3). An electronic pointer such as an electronic pen can be used to perform an interactive writing operation on a face of the display unit 12a (see FIG. 3), such as over an image displayed by the display unit 12a (see FIG. 3). The interactive writing operation means, in this example, writing to be performed in response to a user input. The communication terminal 20 can be used as a client, and the electronic information board 10 can be used as a sever in the information transmission system 100.

The communication terminal 20 may be an electronic information terminal such as a personal computer (PC) such as notebook PC and tablet PC but not limited to these.

The electronic information board 10 and each one of the communication terminals 20 can be connected to one another via a network such as the local network, in which the electronic information board 10 and each one of the communication terminals 20 can obtain identification (ID) information of all of the communication terminals 20 connected to the network. The network may be any communication network such as a wired/wireless local area network (LAN) configured in company, wired/wireless Internet or the like.

The electronic information board 10 generates and displays an information board image on the display unit 12a. The information board image is, for example, an image displayed on the display unit 12a, and an image (i.e., writing information) drawn on the display unit 12a. The transmission service 11 compresses the information board image as compressed data, and transmits compressed data to the communication terminal 20. The communication terminal 20 can be used to view an image by decoding the compressed data.

Further, in addition to the viewing, the communication terminal 20 can operate the electronic information board 10 from a remote location. For example, when a user inputs an operation information to the communication terminal 20, the communication terminal 20 transmits the operation information to the information board application 12 via the transmission service 11. Then, the information board application 12 performs the processing based on the operation information, and updates the information board image.

Further, the updated information board image can be transmitted to the communication terminal 20 as compressed data by the transmission service 11. For example, when a line is drawn on the display of the communication terminal 20 such as a tablet screen by touching the display, the line input by the manual writing is transmitted to the electronic information board 10, and the manual writing information is added on the information board image displayed on the electronic information board 10. Then, the added manual writing information can be transmitted to the communication terminal 20, and then the image having the added manual writing information can be viewed on the communication terminal 20.

In one example embodiment of the present invention, to be described later, each one of the communication terminals 20 can limit a transmission destination of an operation information input from each one of the communication terminals 20. For example, when a terminal A limits a transmission destination of an operation information input from the terminal A, the terminal A may set a terminal B as the transmission destination but may not set a terminal C as the transmission destination. Specifically, each one of the communication terminals 20 can assign transmission allowing/not-allowing information to the operation information, the information board application 12 generates the information board image for each one of the transmission destinations based on the operation information and the transmission allowing/not-allowing information received from each one of the communication terminals 20, and transmits the generated information board image to each one of the transmission destinations.

### (Hardware Configuration of Electronic Information Board)

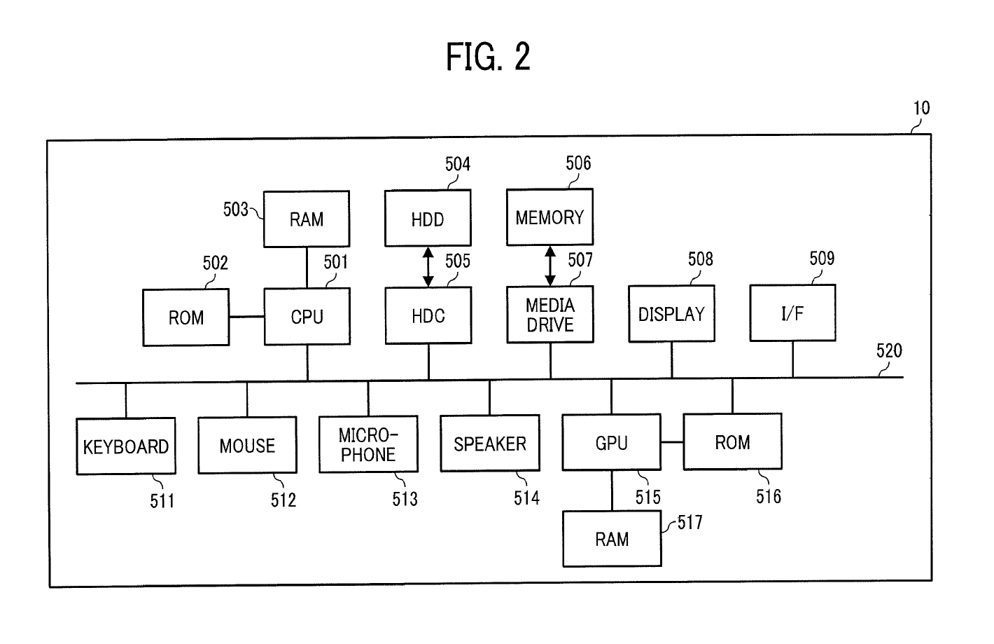

FIG. 2 is a block diagram of a hardware configuration of the electronic information board 10. As illustrated in FIG. 2, the electronic information board 10 includes, for example, a central processing unit (CPU) 501, a read only memory (ROM) 502, a random access memory (RAM) 503, a hard disk drive (HDD) 504, a hard disk controller (HDC) 505, a media drive 507, a display 508 used as an image display device, an interface (UF) 509, a keyboard 511, a mouse 512, a microphone 513, a speaker 514, and a graphics processing unit (GPU) 515, which are connectable one to another by a bus line 520. The electronic information board 10 can be configured without some of the units such as the keyboard 511.

The CPU 501 controls the electronic information board 10 entirely. The ROM 502 stores programs such as initial program loader (IPL) to activate the CPU 501. The RAM 503 is used as a working area of the CPU 501. The HDD 504 stores various data such as programs. The HDC 505 controls data reading and data writing of various data to the HDD 504 under the control of the CPU 501. The media drive 507 controls data reading and data writing to the storage medium 506 such as a flash memory. The display 508 displays various information. The I/F 509 is used to communicate data via the communication network, and can be used for a dongle connection. The GPU 515 is connectable to a ROM 516 and a RAM 517, in which the ROM 516 stores programs to activate the GPU 515, and the RAM 517 is used as a working area of the GPU 515. The bus line 520 includes, for example, an address bus to electrically connect each of the above units and data bus.

The electronic information board 10 of FIG. 1 can implement capabilities of the information board application 12 and the transmission service 11 by executing a given image transmission software by using the CPU 501, in which the information board application 12 can generate one or more images, and the transmission service 11 transmits the one or more generated images.

The communication terminal 20 may be a personal computer (PC) such as notebook PC and tablet PC, which can be operated under various Operation Systems (OSs) such as iOS, Android (registered trademark), Windows (registered trademark), and macOS (registered trademark).

### (Operation of Information Transmission System)

A description is given of an operation of the information transmission system 100 with reference to FIG. 1. The information board application 12 generates one or more images that are to be transmitted to the one or more communication terminals 20, and outputs the one or more images to the transmission service 11. The transmission service 11 converts the generated image into compressed data compressed by the information board application 12, and transmits the compressed data to the one or more communication terminals 20. In a case of FIG. 1, one electronic information board 10 can transmit the compressed data to a plurality of the communication terminals 20 concurrently.

Each of the communication terminals 20 can display the information board image transmitted from the transmission service 11 of the electronic information board 10 on the display of the communication terminal 20, and then an operator such as a user can perform a touching operation and a mouse operation to the image displayed on the display of the communication terminal 20. An operation information that is generated by the touching operation and/or the mouse operation is transmitted to the transmission service 11 of the electronic information board 10.

When the transmission service 11 receives the operation information from the communication terminal 20, the transmission service 11 transmits the operation information to the information board application 12, and then the information board application 12 performs the processing based on the operation information. Since a result obtained by processing the operation information can be transmitted as an image, a user of the communication terminal 20 can perform an interactive operation. In this processing, a transmission service input/output unit 11a, which can be used as identification (ID) information assignment unit, assigns a terminal identification (ID) (e.g., 1, 2, . . . , n) used for identifying the communication terminal 20 to the operation information, and transmits the operation information assigned with the terminal ID to the information board application 12. Therefore, even if the plurality of communication terminals 20 input the operation information, each of the operation information can be correctly identified at the information board application 12.

### (Function of Electronic Information Board)

FIG. 3 is a functional block diagram of the electronic information board 10. As above described, the electronic information board 10 includes the information board application 12 and the transmission service 11.

The information board application 12 and the transmission service 11 can collectively provide an interactive information processing capability to a user, and can generate one or more images to be transmitted to one or more of the communication terminals 20.

As illustrated in FIG. 3, the information board application 12 includes, for example, a display unit 12a, an operation receiver 12b, an execution unit 12c, an image generator 12d, an application input/output unit 12e, and a frame output unit 12f.

The display unit 12a can be devised by the display 508 of the electronic information board 10, and the information board image is displayed on the display unit 12a.

The operation receiver 12b is used as a unit to receive a writing operation or the like. Since a stroke can be displayed on the display 508 by writing an image using a finger or an electronic pointer such as an electronic pen, the display unit 12a can be also used as the operation receiver 12b.

Further, the display unit 12a has an operation panel composed of menu icons for various functions such as changing of colors of the pen used as a part of the operation receiver 12b.

When the operation information such as writing information received by the operation receiver 12b is processed by the execution unit 12c, the image generator 12d generates an information board image, and updates the information board image.

Further, the image generator 12d can superimpose an operation panel layer on the information board image to generate an image to be displayed on the display unit 12a. The generated image is output to the frame output unit 12f. The image output to the frame output unit 12f is acquired by an acquiring unit 11g of the transmission service 11, and then the image is transmitted to the communication terminal 20.

When the electronic information board 10 receives an operation from the communication terminal 20, the operation information transmitted from the communication terminal 20 is input to the application input/output unit 12e via the transmission service input/output unit 11a of the transmission service 11, and then transmitted to the execution unit 12c and processed by the execution unit 12c. When the operation information is assigned with the transmission allowing/not-allowing information, the image generator 12d can generate an image based on the operation information while selecting one or more transmission destinations that the image is allowed to be transmitted based on the transmission allowing/not-allowing information. The transmission allowing/not-allowing information can be used to designate the destination (e.g., communication terminal 20) that the image generated from the operation information can be transmitted.

The transmission service 11 is a module of the electronic information board 10 in the information transmission system 100. The transmission service 11 includes, for example, a transmission service input/output unit 11a, a transmission controller 11b, a first transmission information manager 11c, a first communication controller 11d, an encoder controller 11e, an encoder 11f, and an acquiring unit 11g. The transmission controller 11b, the first transmission information manager 11c and the first communication controller 11d can collectively configure a transmission module 13. The encoder controller 11e and the encoder 11f can collectively configure a codec module 14.

The execution unit 12c is a module to execute capabilities of the electronic information board 10. The application input/output unit 12e receives data such as the operation information from the transmission service input/output unit 11a. Further, the application input/output unit 12e can be also used as the operation information processing unit that converts the received data to data having format processable by the execution unit 12c, and outputs the converted data. Further, the application input/output unit 12e transmits data of service start and service stop to the transmission service input/output unit 11a.

The frame output unit 12f outputs an image to be transmitted to the communication terminal 20, in which the frame output unit 12f can be used as an image generator that generates and outputs the image. For example, the frame output unit 12f outputs compressed data formatted with H.264/AVC, which is generated from an image of RGB (red, green, blue) bitmap.

The transmission service input/output unit 11a receives data such as data of service start and service stop output from the application input/output unit 12e. Further, the transmission service input/output unit 11a transmits data such as an operation information to the application input/output unit 12e. The first transmission information manager 11c manages encoding setting for transmission, and information of the communication terminal 20 that is being connected. The first communication controller 11d can be used for transmitting an image, controls the transmission entirely, and instructs the activation and deactivation of the codec module 14.

The encoder controller 11e acquires frame images with a frame rate designated by the transmission controller 11b, and transmits the acquired frame images to the encoder 11f. The encoder 11f acquires the image from the acquiring unit 11g, and generates compressed data from the acquired image. The acquiring unit 11g can be used as an image acquiring unit, in which the acquiring unit 11g acquires the frame images output from the frame output unit 12f of the information board application 12.

### (Hardware Configuration of Communication Terminal)

A description is given of the communication terminal 20. The hardware configuration of the communication terminal 20 is substantially similar to the hardware configuration of the electronic information board 10 of FIG. 2.

### (Function of Communication Terminal)

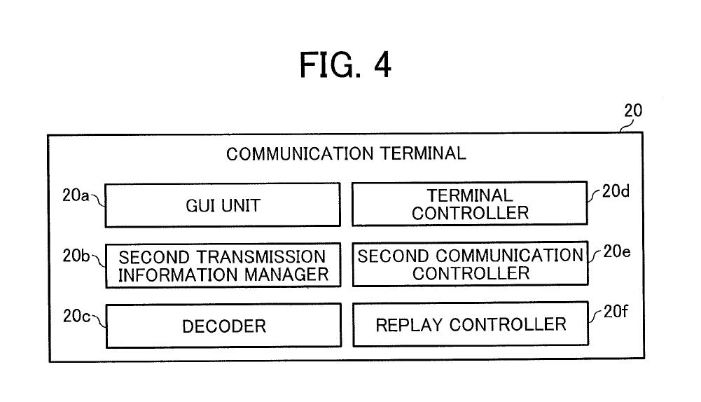

FIG. 4 is a functional block diagram of the communication terminal 20. As illustrated FIG. 4, the communication terminal 20 includes, for example, a graphical user interface (GUI) unit 20a, a second transmission information manager 20b, a decoder 20c, a terminal controller 20d, a second communication controller 20e and a replay controller 20f.

The GUI unit 20a is used to display one or more user interfaces (UI). By using the GUI unit 20a, one user of one of the communication terminals 20 can set information indicating whether an operation information can be transmitted to each one of the communication terminals 20 (hereinafter, the transmission allowing/not-allowing information), in which one user of one of the communication terminals 20 can set the transmission allowing/not-allowing information for each one of the communication terminals 20.

Further, the GUI unit 20a can be used to change the transmission allowing/not-allowing information. When the one user changes the transmission allowing/not-allowing information via the GUI unit 20a, the transmission allowing/not-allowing information is updated to the changed transmission allowing/not-allowing information.

The second transmission information manager 20b retains the transmission allowing/not-allowing information temporary, and correlates the transmission allowing/not-allowing information to the operation information. Specifically, the second transmission information manager 20b correlates the operation information input to the information board image from the communication terminal 20, and information indicating one or more communication terminals 20 that the operation information is allowed to be transmitted and information indicating one or more communication terminals 20 that the operation information is not allowed to be transmitted.

The terminal controller 20d controls the communication terminal 20 entirely such as communication start and communication stop. The second transmission information manager 20b retains transmission-related information such as image encoding settings. The second communication controller 20e controls communication of the communication terminal 20 with the electronic information board 10, and transmits and receives data between the transmission service 11 of the electronic information board 10. The replay controller 20f inputs compressed data to the decoder 20c. The decoder 20c decodes the compressed data, and then the decoded compressed data is displayed.

### First Example Embodiment

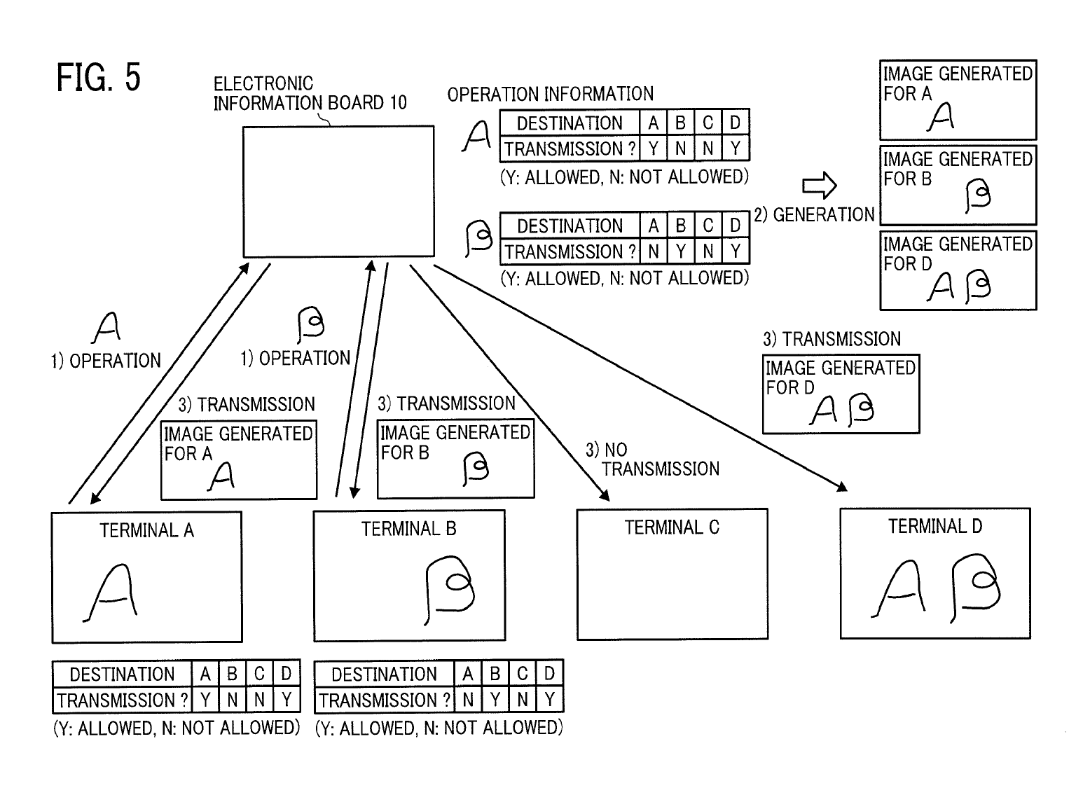

A description is given of a first example embodiment with reference to FIG. 5, in which when one user inputs an operation to the communication terminal 20, the operation is transmitted from the communication terminal 20 to the electronic information board 10, and then an image generated at the electronic information board 10 is transmitted to one or more of the communication terminals 20. In this example case, the communication terminal 20 is simply referred to as the terminal, in which four communication terminals 20 are referred to as a terminal A, a terminal B, a terminal C, and a terminal D.

In the first example embodiment, as indicated in an example case of FIG. 5, when the terminal A is operated to input an image “A” and the input image “A” is transmitted to the electronic information board 10, and the terminal B is operated to input an image “B” and the input image “B” is transmitted to the electronic information board 10, the terminal A sets the terminal A and the terminal D as the transmission destination, but does not set the image to the terminal B and the terminal C as the transmission destination, and the terminal B sets the terminal Band the terminal D as the transmission destination, but does not set the image to the terminal A and the terminal C as the transmission destination. Therefore, in the example case of FIG. 5, the terminal A transmits the image “A” to the terminal A and the terminal D but does not transmit the image “A” to the terminal B and the terminal C, and the terminal B transmits the image “B” to the terminal B and the terminal D but does not transmit the image “B” to the terminal A and the terminal C.

When the terminal A is operated and the terminal B is operated as illustrated in FIG. 5, each of the operation information is transmitted to the information board application 12 with the transmission allowing/not-allowing information. The transmission allowing/not-allowing information from the terminal A indicates that the operation information can be transmitted from the terminal A to the terminal A and the terminal D, but cannot be transmitted to the terminal B and the terminal C. Further, the transmission allowing/not-allowing information from the terminal B indicates that the operation information can be transmitted from the terminal B to the terminal B and the terminal D, but cannot be transmitted to the terminal A and the terminal C.

By setting the transmission allowing/not-allowing information, the transmission destination can be limited. When the transmission not-allowing information is set, the concerned operation information is not transmitted to one or more of the transmission destination terminals from the sender terminal when the concerned operation information is not required for the one or more of the transmission destination terminals. When the transmission allowing information is set, the concerned operation information is transmitted to one or more of the transmission destination terminals from the sender terminal when the concerned operation information is required for the one or more of the transmission destination terminals.

In the example case of FIG. 5, the information board image displayed on the display unit 12a of the electronic information board 10 becomes an image “AB,” in which the information board image includes the images corresponding to the operation information input from the terminal A and the terminal B. Further, if the viewing of the information board image displayed on the display unit 12a is not required, the information board image may not be displayed on the display unit 12a.

Then, the information board application 12 generates a transmission-use image to be transmitted to the terminal A based on the operation information and the transmission allowing/not-allowing information received from the terminal A, in which the transmission-use image to be transmitted to the terminal A is the image “A” matched to the operation information received from the terminal A and displayed as the information board image. Further, the information board application 12 generates a transmission-use image to be transmitted to the terminal B based on the operation information and the transmission allowing/not-allowing information received from the terminal B, in which the transmission-use image to be transmitted to the terminal B is the image “B” matched to the operation information received from the terminal B and displayed as the information board image. Further, the information board application 12 generates a transmission-use image to be transmitted to the terminal D based on the operation information and the transmission allowing/not-allowing information, received from the terminals A and B, in which the transmission-use image to be transmitted to the terminal D is the image “AB.” Then, the transmission service 11 transmits the transmission-use images “A,” “B,” and “AB” respectively to the terminals A, B, and D.

As above described, when one terminal limits the transmission destination, the information board image displayed on the display 508 of the electronic information board 10 can be shared by all of the terminals, can be shared by some of the terminals, or cannot be shared by all of the terminals.

In this configuration, a person that can view the information board image displayed on the display 508 (i.e., display unit 12a) of the electronic information board 10 is a person that is allowed to view the image without limitation, which means this person may be a neutral person or an administrator of an in-house meeting and business meeting. If the neutral person or administrator is not required to view the image, the information board image may not be displayed on the display unit 12a such as the display 508

### (Sequence of Generation and Transmission of Transmission-Use Image)

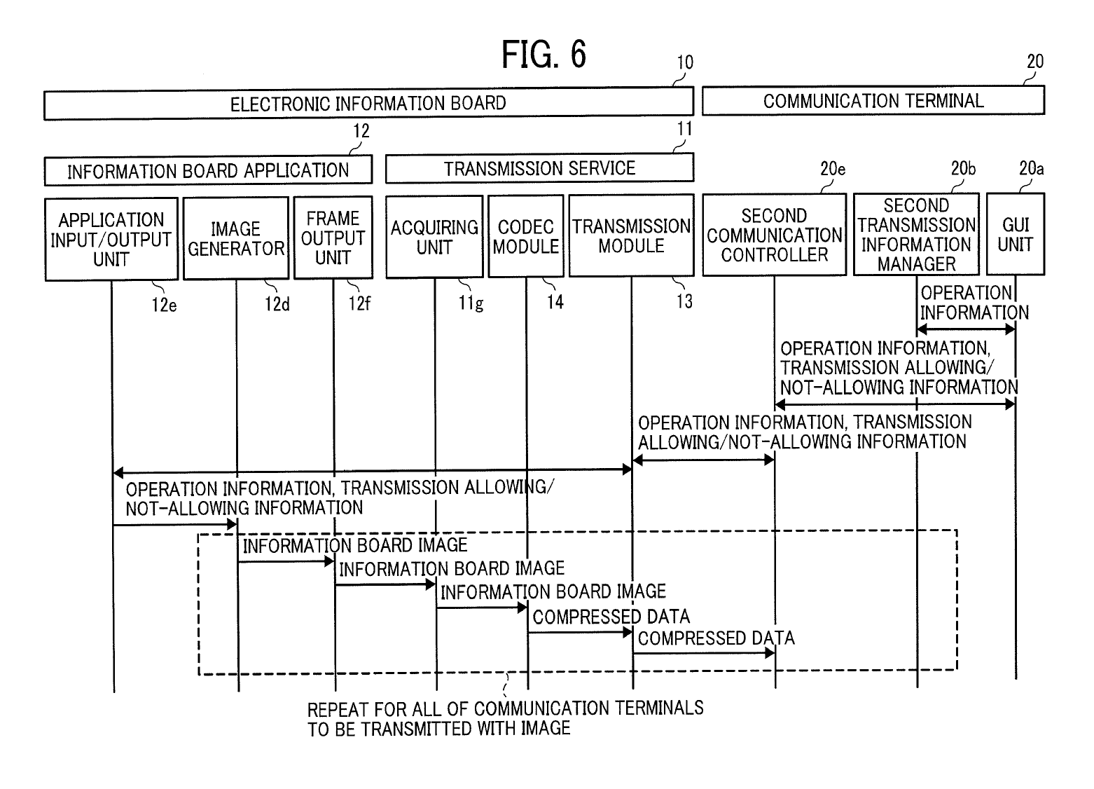

FIG. 6 illustrates a sequence of generation and transmission of the transmission-use image of the electronic information board 10, in which the transmission-use image is an information board image to be transmitted from the electronic information board 10 to the communication terminal 20.

At the communication terminal 20, after receiving the operation information from the GUI 20a, the second transmission information manager 20b assigns the transmission allowing/not-allowing information to the operation information received from the GUI 20a, and transmits the operation information to the second communication controller 20e.

At the information board application 12, the image generator 12d generates the information board image for each of the transmission destinations such as each of the communication terminals 20, and outputs the information board image to the frame output unit 12f. The image generator 12d performs this process for all of communication terminals 20 set as the transmission destinations.

At the transmission service 11, the acquiring unit 11g acquires the image output to the frame output unit 12f, and transmits the image to the codec module 14. The codec module 14 compresses the image to generate image stream data, and transmits the image stream data to the transmission module 13. The transmission module 13 transmits the image stream data to the communication terminal 20.

After the communication terminal 20 receives the image stream data, the decoder 20c decodes the image stream data, and then the information board image is displayed on the display of the communication terminal 20.

### Second Example Embodiment

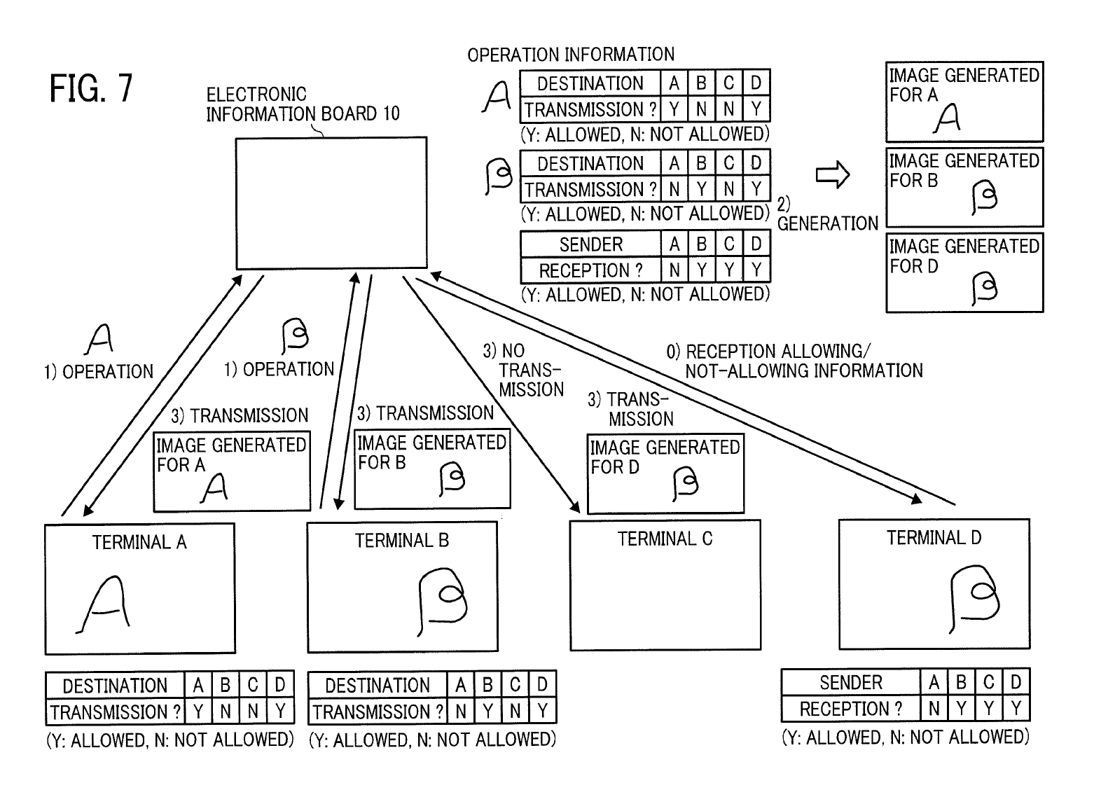

A description is given of a second example embodiment with reference to FIG. 7, in which when one user inputs an operation to the communication terminal 20, the operation is transmitted from the communication terminal 20 to the electronic information board 10, and then an image generated at the electronic information board 10 is transmitted to one or more of the communication terminals 20. In this example case, the communication terminal 20 is simply referred to as the terminal, in which four communication terminals 20 are referred to as the terminal A, the terminal B, the terminal C, and the terminal D.

In the second example embodiment, as indicated in an example case of FIG. 7, when the terminal A is operated to input an image “A” and the input image “A” is transmitted to the electronic information board 10, and the terminal B is operated to input an image “B” and the input image “B” is transmitted to the electronic information board 10, the terminal A sets the terminal A and the terminal D as the transmission destination, but does not set the image to the terminal B and the terminal C as the transmission destination, and the terminal B sets the terminal B and the terminal D as the transmission destination, but does not set the image to the terminal A and the terminal C as the transmission destination. Therefore, in the example case of FIG. 7, the terminal A transmits the image “A” to the terminal A and the terminal D but does not transmit the image “A” to the terminal B and the terminal C, and the terminal B transmits the image “B” to the terminal B and the terminal D but does not transmit the image “B” to the terminal A and the terminal C.

Further, it is set that the terminal D does not receive an image from the terminal A, which means that the terminal D receives images from the terminal B, the terminal C, and the terminal D but does not receive the image from the terminal A, in which the terminal D sets reception allowing/not-allowing information for each one of the terminals. By setting the reception allowing/not-allowing information in the terminal D, the terminal D can receive images from other terminals that the terminal D allows to receive, in which each of the other terminals can be referred to as a sender terminal, and the terminal D can be referred to as a receiver terminal. The reception allowing/not-allowing information can be used to designate the sender apparatus (e.g., terminal B, C, D) that the receiver apparatus (e.g., terminal D) can receive the image generated from the operation information. In the example case of FIG. 7, the terminal D sets the reception not-allowing information for the terminal A so that the terminal D but does not receive the image from the terminal A, and sets the reception allowing information for the terminal B, the terminal C, and the terminal D so that the terminal D receives the images from the terminal B, the terminal C, and the terminal D. A user of the terminal D can set the reception allowing/not-allowing information for each of the sender terminals using the GUI unit 20a of the terminal D. Further, the user can change the reception allowing/not-allowing information for each of the sender terminals using the GUI unit 20a of the terminal D.

For example, when one terminal sets the reception not-allowing information for the sender terminal because a user of the one terminal does not need to view the image or the user of the one terminal one does not want view the image, even if the operation information of the sender terminal is transmitted to the one terminal, the information board image is not displayed on the one terminal used as the receiver terminal. Therefore, even if a plurality of sender terminals outputs the operation information, the receiver terminal can display the information board image by selecting the information board images corresponding to the operation information of the plurality of the sender terminals.

When the terminal A is operated and the terminal B is operated as illustrated in FIG. 7, each of the operation information is transmitted to the information board application 12 with the transmission allowing/not-allowing information. The transmission allowing/not-allowing information from the terminal A indicates that the operation information can be transmitted from the terminal A to the terminal A and the terminal D, but cannot be transmitted to the terminal B and the terminal C. Further, the transmission allowing/not-allowing information from the terminal B indicates that the operation information can be transmitted from the terminal B to the terminal B and the terminal D, but cannot be transmitted to the terminal A and the terminal C.

Then, the information board application 12 generates a transmission-use image to be transmitted to each of the terminals based on the operation information, the transmission allowing/not-allowing information, and the reception allowing/not-allowing information received from the terminals.

Specifically, the information board application 12 generates a transmission-use image to be transmitted to the terminal A based on the operation information and the transmission allowing/not-allowing information received from the terminal A, in which the transmission-use image to be transmitted to the terminal A is the image “A” matched to the operation information received from the terminal A and displayed as the information board image. Further, the information board application 12 generates a transmission-use image to be transmitted to the terminal B based on the operation information and the transmission allowing/not-allowing information received from the terminal B, in which the transmission-use image to be transmitted to the terminal B is the image “B” matched to the operation information received from the terminal B and displayed as the information board image. Further, the information board application 12 generates a transmission-use image to be transmitted to the terminal D based on the operation information, the transmission allowing/not-allowing information received from the terminal B, and the reception allowing/not-allowing information received from the terminal D, in which the transmission-use image to be transmitted to the terminal D is an image “B.”

In the example case of FIG. 7, the terminal A sets the transmission allowing information for the terminal D to transmit the image “A” to the terminal D. However, since the terminal D sets the reception not-allowing information for the terminal A, the terminal D does not receive the image from the terminal A, but the image “B” of the terminal B alone is transmitted to the terminal D. In the second example embodiment, if the transmission allowing/not-allowing information and the reception allowing/not-allowing information do not match with each other, the reception allowing/not-allowing information is used over the transmission allowing/not-allowing information, which means the reception allowing/not-allowing information is set with a priority. Further, if the transmission allowing/not-allowing information and the reception allowing/not-allowing information do not match with each other, the transmission allowing/not-allowing information can be used over the reception allowing/not-allowing information, which means the transmission allowing/not-allowing information is set with a priority.

### Third Example Embodiment

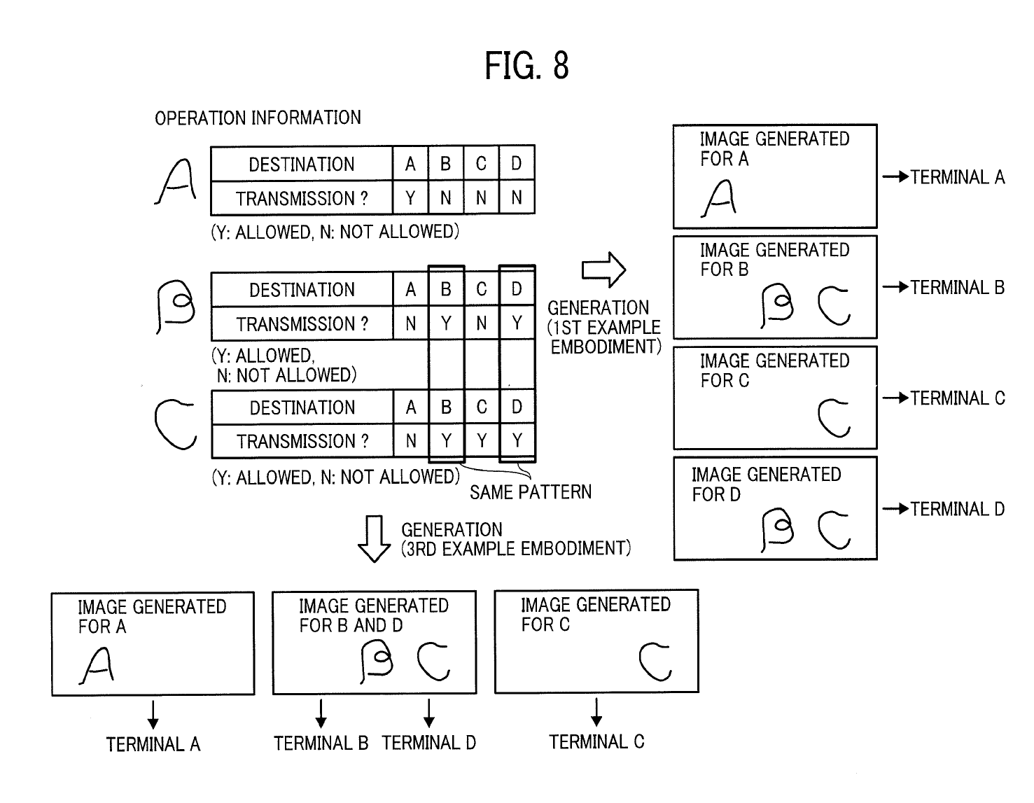

A description is given of a third example embodiment with reference to FIG. 8, in which when one user inputs an operation to the communication terminal 20, the operation is transmitted from the communication terminal 20 to the electronic information board 10, and then an image generated at the electronic information board 10 is transmitted to one or more of the communication terminals 20.

In the third example embodiment, as indicated in FIG. 8, the transmission allowing/not-allowing information for the terminal B and the terminal D set in the terminal B and the transmission allowing/not-allowing information for the terminal B and the terminal D set in the terminal C are the same information having the same pattern. Therefore, the transmission-use image transmitted from the electronic information board 10 to the terminal B and the transmission-use image transmitted from the electronic information board 10 to the terminal D becomes the same image. In this case, the transmission-use image to be transmitted to the terminal B and the transmission-use image to be transmitted to the terminal D are not generated separately, but the transmission-use image to be transmitted to the terminal B and the terminal D is generated as one transmission-use image, and the generated one transmission-use image is transmitted to each one of the terminal B and the terminal D.

Therefore, when a terminal group having a plurality of the terminals to be transmitted with the same transmission-use image exists, the electronic information board 10 generates the same transmission-use image and transmits the same transmission-use image to the plurality of the terminals of the terminal group. Further, if the information transmission system 100 includes a terminal not belonging to the terminal group, the electronic information board 10 generates a transmission-use image for the terminal not belonging to the terminal group, and transmits the transmission-use image to the terminal not belonging to the terminal group.

Specifically, by comparing the transmission allowing/not-allowing information of all of the terminals, the terminal group having the plurality of the terminals set with the same transmission allowing/not-allowing information for the concerned operation information can be determined. If the terminal group exists, one transmission-use image is generated as the common image for the plurality of the terminals composing the terminal group, and the generated one transmission-use image (i.e., common image) is transmitted to each one of the plurality of the terminals composing the terminal group, in which the common image is generated for one time.

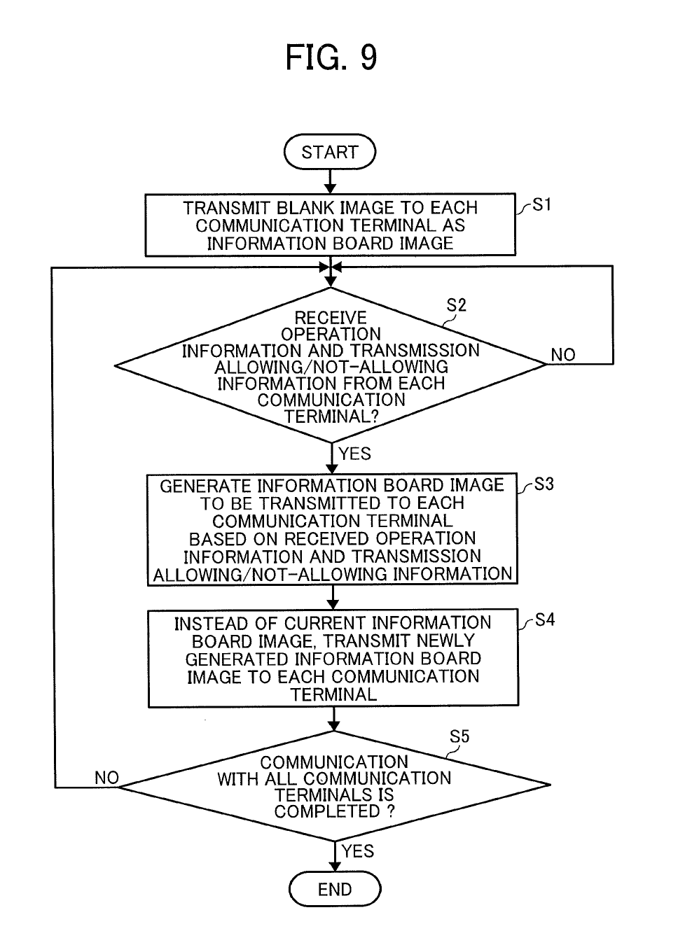

A description is given of a first example of the control flow for the electronic information board 10 with reference to FIG. 9. FIG. 9 is a flow chart illustrating the steps of a first example of the control process performed for the electronic information board 10. The process of FIG. 9 can be executed by the CPU 501 of the electronic information board 10 by executing a program. The program can be executed by the CPU 501 such as a processor or circuitry that performs the image transmission method, in which the control process is started when the electronic information board 10 and the plurality of communication terminals 20 are connected or coupled via the network.

At step S1, a blank image is transmitted to each one of the communication terminals 20 as the information board image from the electronic information board 10.

At step S2, it is determined whether the electronic information board 10 receives the operation information and the transmission allowing/not-allowing information assigned to the operation information from each one of the communication terminals 20. If the determination at step S2 is Yes, the sequence proceeds to step S3, and if the determination at step S2 is No, the step S2 is performed again.

At step S3, based on the operation information and the transmission allowing/not-allowing information assigned to each one of the communication terminals 20, the information board image to be transmitted to each of the communication terminals 20 is generated.

At step S4, instead of the current information board image, a newly generated information board image is transmitted to each of the communication terminals 20, with which the information board image transmitted to each of the communication terminals 20 is updated.

At step S5, it is determined whether the communication with all of the communication terminals 20 is completed. If the determination at step S5 is Yes, the sequence ends. If the determination at step S5 is No, the sequence returns to step S2.

As above described, when the operation information and the transmission allowing/not-allowing information are transmitted from the communication terminal 20 to the electronic information board 10, the information board image to be transmitted to the communication terminal 20 from the electronic information board 10 can be updated based on the operation information and the transmission allowing/not-allowing information.

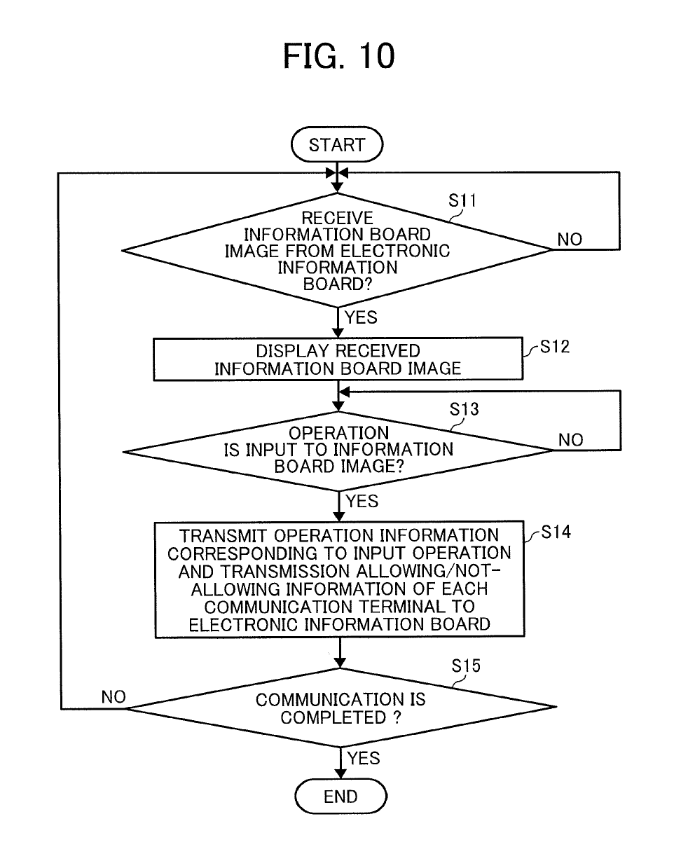

A description is given of a control flow for the communication terminal 20 with reference to FIG. 10. FIG. 10 is a flow chart illustrating the steps of one example control process performed for the communication terminal 20. The process of FIG. 10 can be executed by the CPU of the communication terminal 20 by executing an algorism, in which the control process is started when the electronic information board 10 and at least one of the plurality of communication terminals 20 are connected or coupled via the network.

At step S11, the communication terminal 20 determines whether the communication terminal 20 receives the information board image from the electronic information board 10. If the determination at step S11 is Yes, the sequence proceeds to step S12, and if the determination at step S11 is No, the step S11 is performed again.

At step S12, the communication terminal 20 displays the received information board image. Specifically, when a specific communication terminal, which is one of the communication terminals 20, receives the information board image, the specific communication terminal displays the received information board image on the display of the specific communication terminal or the specific communication terminal displays the received information board image on an image output device (e.g., monitor, projector) connected or coupled to the specific communication terminal.

At step S13, the communication terminal 20 determines whether an operation is input to the information board image by using the communication terminal 20. If the determination at step S13 is Yes, the sequence proceeds to step S14, and if the determination at step S13 is No, the step S13 is performed again.

At step S14, the communication terminal 20 transmits the operation information such as image drawing information corresponding to the input operation and the transmission allowing/not-allowing information of each one of the communication terminals 20 assigned to the operation information to the electronic information board 10.

At step S15, it is determined whether the communication with the electronic information board 10 is completed. If the determination at step S15 is Yes, the sequence ends. If the determination at step S15 is No, the sequence returns to step S 112.

As above described, the first example of the control flow for the electronic information board 10 is described with reference to FIG. 9. A description is given of another example of the control flow for the electronic information board 10 as a second example and a third example.

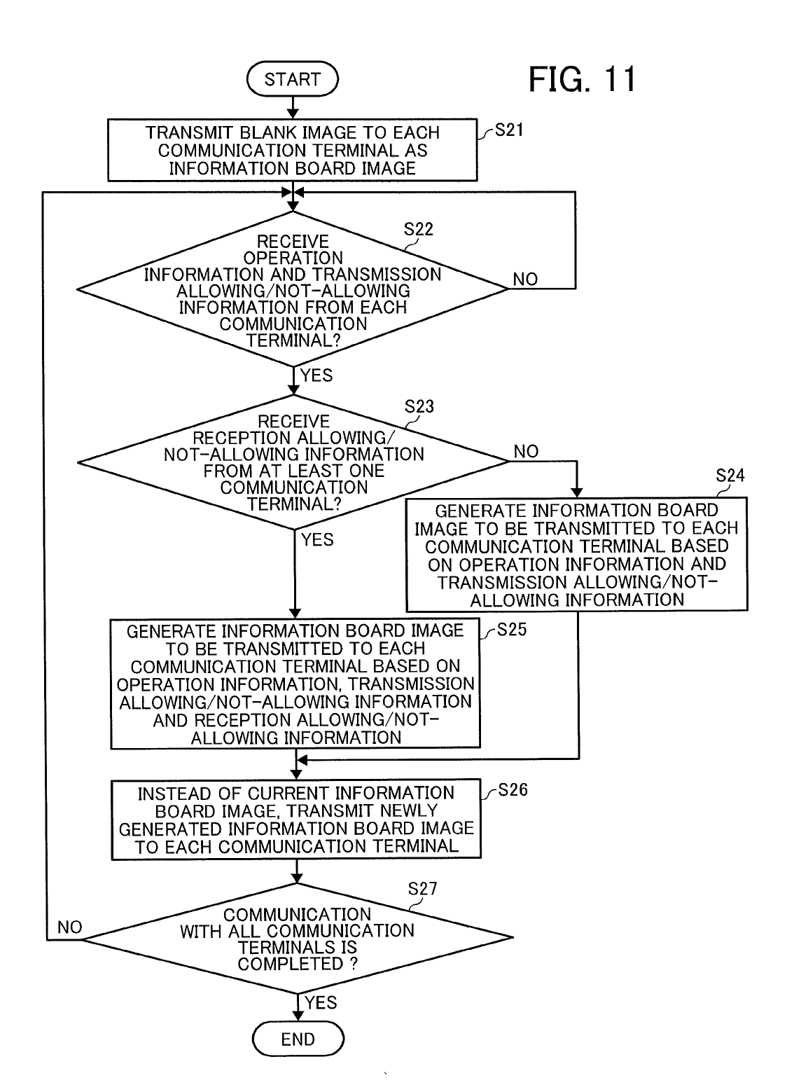

A description is given of a second example of the control flow for the electronic information board 10 with reference to FIG. 11. FIG. 11 is a flow chart illustrating the steps of a second example of the control process performed for the electronic information board 10. The process of FIG. 11 can be executed by the CPU 501 of the electronic information board 10 by executing a program, in which the control process is started when the electronic information board 10 and the plurality of communication terminals 20 are connected or coupled via the network.

At step S21, a blank image is transmitted to each one of the communication terminals 20 as the information board image from the electronic information board 10.

At step S22, it is determined whether the electronic information board 10 receives the operation information and the transmission allowing/not-allowing information assigned to the operation information from each one of the communication terminals 20. If the determination at step S22 is Yes, the sequence proceeds to step S23, and if the determination at step S22 is No, the step S22 is performed again.

At step S23, it is determined whether the electronic information board 10 receives the reception allowing/not-allowing information assigned to the operation information from at least one of the communication terminals 20. Specifically, it is determined whether the electronic information board 10 receives the reception allowing/not-allowing information from the communication terminal 20 to be used as the receiver apparatus that receives the operation information from other one of the communication terminals 20 used as the sender apparatus. When the communication terminal 20 to be used as the receiver apparatus is set with the reception allowing/not-allowing information via the GUI unit 20a of the communication terminal 20, the communication terminal 20 to be used as the receiver apparatus transmits the reception allowing/not-allowing information to the electronic information board 10. If the determination at step S23 is No, the sequence proceeds to step S24, and if the determination at step S23 is Yes, the sequence proceeds to step S25.

At step S24, the information board image to be transmitted to each one of the communication terminals 20 is generated based on the operation information and the transmission allowing/not-allowing information.

At step S25, the information board image to be transmitted to each one of the communication terminals 20 is generated based on the operation information, the transmission allowing/not-allowing information and the reception allowing/not-allowing information.

At step S26, instead of the current information board image, a newly generated information board image is transmitted to each of the communication terminals 20, with which the information board image transmitted to each of the communication terminals 20 is updated.

At step S27, it is determined whether the communication with all of the communication terminals 20 is completed. If the determination at step S27 is Yes, the sequence ends. If the determination at step S27 is No, the sequence returns to step S22.

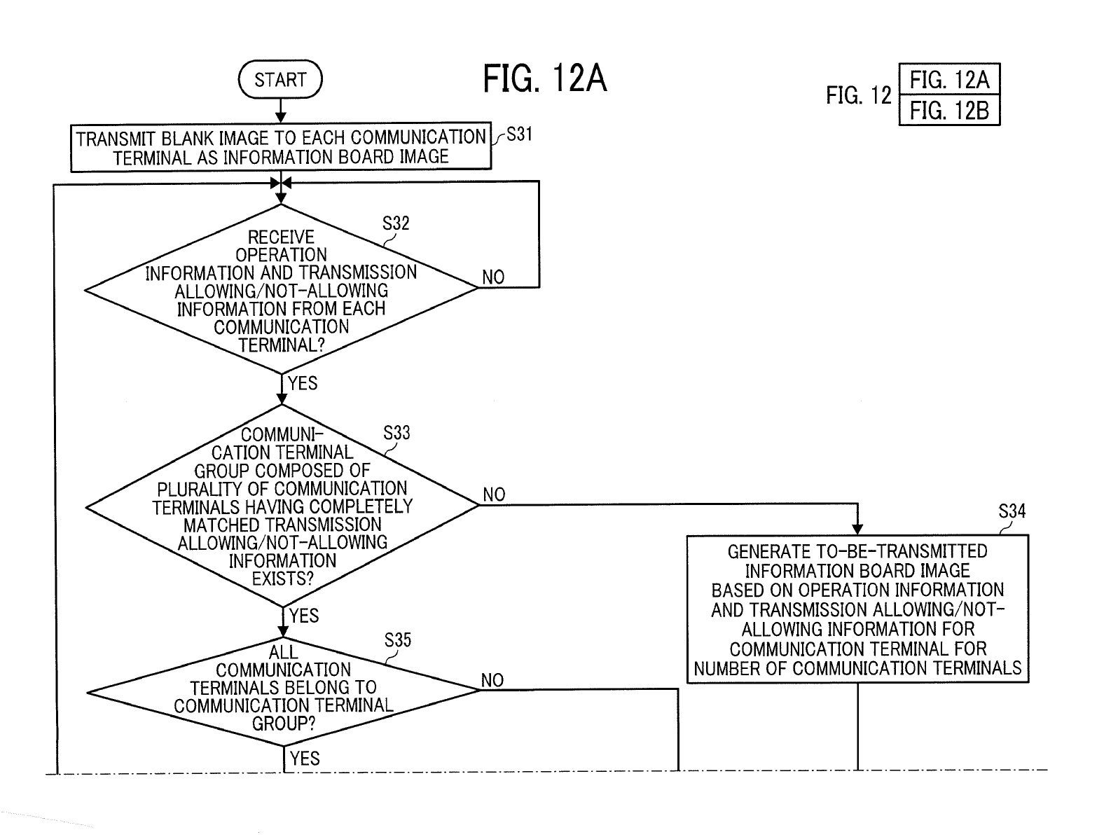

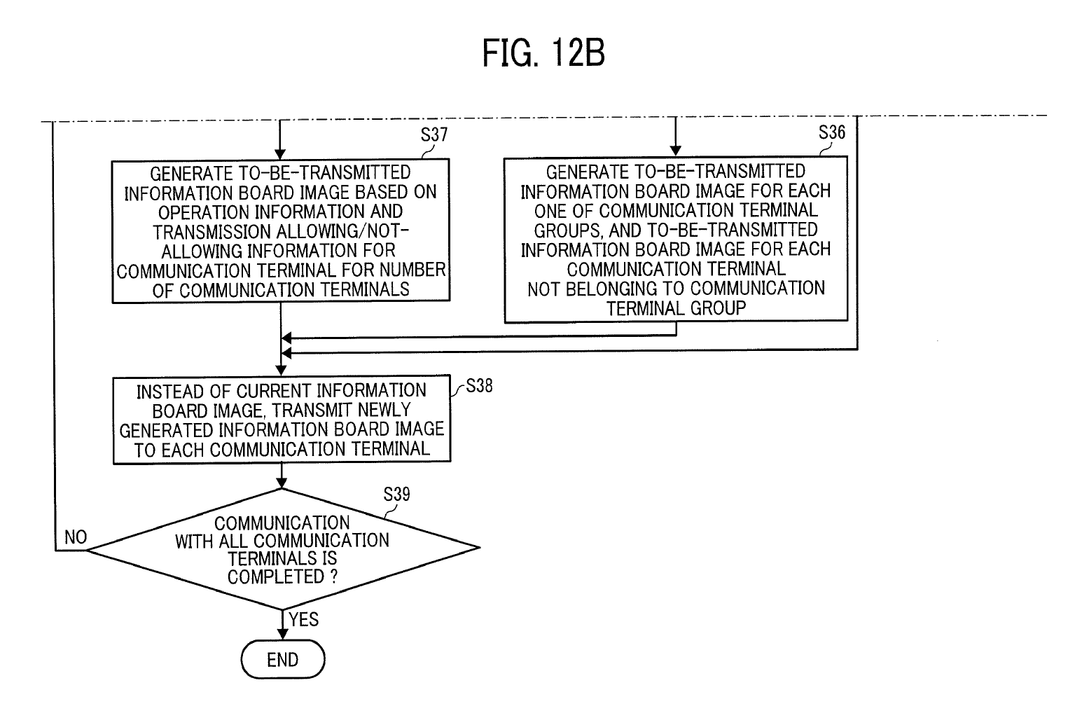

A description is given of a third example of the control flow for the electronic information board 10 with reference to FIG. 12

FIGS. 12A and 12B is a flow chart illustrating the steps of a third example of the control process performed for the electronic information board 10. The process of FIG. 12 can be executed by the CPU 501 of the electronic information board 10 by executing a program, in which the control process is started when the electronic information board 10 and the plurality of communication terminals 20 are connected or coupled via the network.

At step S31, a blank image is transmitted to each one of the communication terminals 20 as the information board image from the electronic information board 10.

At step S32, it is determined whether the electronic information board 10 receives the operation information and the transmission allowing/not-allowing information for the operation information from each one of the communication terminals 20. If the determination at step S32 is Yes, the sequence proceeds to step S33, and if the determination at step S32 is No, the step S32 is performed again.

At step S33, it is determined whether a communication terminal group composed of a plurality of communication terminals 20 having the completely matched transmission allowing/not-allowing information exists. If the determination at step S33 is No, the sequence proceeds to step S34, and if the determination at step S33 is Yes, the sequence proceeds to step S35.

At step S34, the information board images to be transmitted to each one of the communication terminals 20 are generated based on the operation information and the transmission allowing/not-allowing information. Therefore, the number of the generated information board images becomes equal to the number of the communication terminals 20.

At step S35, it is determined whether the all of the communication terminals 20 belong to the communication terminal group determined at step S33. If the determination at step S35 is No, the sequence proceeds to step S36, and if the determination at step S35 is Yes, the sequence proceeds to step S37.

At step S36, the information board image is generated for each one of the communication terminal groups, and the information board image is generated for each one of the communication terminals 20 not belonging to the communication terminal groups based on the operation information and the transmission allowing/not-allowing information. Therefore, the number of information board images generated for the communication terminal groups becomes equal to the number of the communication terminal groups, and the number of information board images generated for the communication terminals 20 not belonging to the communication terminal groups becomes equal to the number of the communication terminals 20 not belonging to the communication terminal group.

At step S37, the information board image is generated for the number of the communication terminal groups based on the operation information and the transmission allowing/not-allowing information. Therefore, the number of information board images generated for the communication terminal groups becomes equal to the number of the communication terminal groups.

At step S38, instead of the current information board image, a newly generated information board image is transmitted to each of the communication terminals 20, with which the information board image transmitted to each of the communication terminals 20 is updated.

At step S39, it is determined whether the communication with all of the communication terminals 20 is completed. If the determination at step S39 is Yes, the sequence ends. If the determination at step S39 is No, the sequence returns to step S32.

The above described information transmission system 100 includes the plurality of communication terminals 20 and the electronic information board 10. The plurality of communication terminals 20 can share the interactive information processing capability via the network. The electronic information board 10 receives the operation information, input from the communication terminal 20, and transmits images to the plurality of communication terminals 20 having the interactive information processing capability via the network. When the input operation is performed on the communication terminal 20, the communication terminal 20 outputs operation information, and the transmission allowing/not-allowing information assigned to the operation information to the electronic information board 10, in which the transmission allowing/not-allowing information indicates whether the operation information can be transmitted to one or more of the communication terminals 20. The electronic information board 10 generates the transmission-use images to be transmitted to one or more of the communication terminals 20 based on the operation information and the transmission allowing/not-allowing information

As to the above described example embodiments, when a user inputs an image by using one of the communication terminals 20 by using the interactive information processing capability, the input image can be transmitted to one or more specific communication terminals alone, in which the user can select the transmission destination of the image input by using one of the communication terminals 20.

As to the above described example embodiments, when the operation information is input from the communication terminals 20, the operation information and the transmission allowing/not-allowing information are correlated for each of the communication terminals 20. Therefore, when an image is generated for each one of the communication terminals 20, the image can be generated for each one of the communication terminals 20,based on the operation information and the transmission allowing/not-allowing information, and then transmitted to each one of the communication terminals 20, in which a sender apparatus can designate a specific receiver apparatus that can receive the image from the sender apparatus, and the sender apparatus can designate a specific receiver apparatus that cannot receive the image from the sender apparatus.

Further, the electronic information board 10 can provide the interactive information processing capability to the plurality of communication terminals 20 via the network. In this case, a software program to implement the interactive information processing capability is not required to be installed or downloaded to each one of the communication terminals 20.

Further, the electronic information board 10 can generate the transmission-use image to be transmitted to one or more of specific communication terminals based on the operation information assigned with the transmission allowing information, in which the transmission-use image can be generated based on the operation information that is to be transmitted to the one or more of specific communication terminals that are allowed to receive the transmission-use image.

Further, when the communication terminal 20 can include a first operation unit as a part of the GUI unit 20a to set the transmission allowing/not-allowing information, with which the transmission allowing/not-allowing information can be set as required via the first operation unit, and thereby the transmission destination can be added or deleted as required.

Further, the first operation unit can include a change mode to change the transmission allowing/not-allowing information, with which the transmission allowing/not-allowing information can be changed via the first operation unit, and thereby the transmission destination can be changed as required. Further, the first operation unit may not include the change mode.

Further, the communication terminal 20 can output the reception allowing/not-allowing information to the electronic information board 10. For example, a user of one of the communication terminals 20 can set the reception allowing/not-allowing information for each one of the communication terminals 20 to indicate one or more communication terminals 20 that can send the operation information to the one of the communication terminals 20. When the electronic information board 10 generates the transmission-use image based on the reception allowing/not-allowing information, one or more of specific communication terminals set with the reception allowing information alone can receive the transmission-use by using the interactive information processing capability, in which the user of one of the communication terminals 20 can select the sender communication terminal that the one of the communication terminal 20 can receive the image.

Further, when the electronic information board 10 sets the priority on the reception allowing/not-allowing information if the transmission allowing/not-allowing information and the reception allowing/not-allowing information do not match with each other, the user of communication terminal 20 used as the can determine which transmission-use image is to be viewed by using the receiver apparatus.

Further, when the communication terminal 20 can include a second operation unit, which may be a part of the GUI unit 20a, that can set the reception allowing/not-allowing information, in which the reception allowing/not-allowing information can be set as required via the second operation unit, and thereby the sender apparatus can be changed as required, and can be added or deleted as required.

Further, the second operation unit can include a change mode to change the reception allowing/not-allowing information, with which the reception allowing/not-allowing information can be changed via the second operation unit as required, and thereby the sender apparatus can be changed as required.

Further, when the same transmission-use image is to be transmitted to two or more communication terminals 20 from the electronic information board 10, the electronic information board 10 generates the same one transmission-use image, and transmits the generated transmission-use image to each one of the two or more communication terminals 20. With employing this configuration, the processing time for the image generation can be reduced and a region or area used in the memory can be reduced. Further, as to the above described image transmission method, an image can be transmitted between the plurality of communication terminals 20 having the interactive information processing capability via the network. The image transmission method includes acquiring information including an operation information input to the communication terminal 20 and transmission allowing/not-allowing information set for each one of the communication terminals 20 indicating whether the operation information is to be transmitted to each one of the communication terminal 20, generating image data to be transmitted to each one of the communication terminal 20 based on the operation information and the transmission allowing/not-allowing information, and transmitting the generated image data to each one of the communication terminal 20. Further, the image transmission method can be stored in the memory as a program

With employing this configuration, an image input from one of the communication terminals 20 can be transmitted to the specific communication terminal alone by using the interactive information processing capability, in which the user can select the transmission destination of the image input from one of the communication terminals 20.

As above described, the electronic information board 10 includes the display 508 (display unit 12a) that can display an image corresponding to the operation information. Therefore, as one variant example, the Information including the above described transmission allowing/not-allowing information set for the communication terminal 20 can further include additional transmission allowing/not-allowing information such as additional transmission allowing information or additional transmission not-allowing information indicating whether the operation information is to be transmitted to the display 508 (display unit 12a) and the image input at the communication terminal 20 is to be displayed by using the display unit 12a. When additional transmission allowing information is set, a user allows the displaying the information board image on the display unit 12a, and when additional transmission not-allowing information is set, the user does not allows the displaying the information board image on the display unit 12a.

Further, as to the above described example embodiment, the electronic information board 10 start to provide the interactive information processing capability when the electronic information board 10 and the plurality of communication terminals 20 are connected or coupled. However, the electronic information board 10 can start to provide the interactive information processing capability when the electronic information board 10 and at least one of the communication terminals 20 are connected or coupled.

Further, the information transmission apparatus such as the electronic information board 10 may not need to include the display 508 (display unit 12a), in which the information transmission apparatus provides the interactive information processing capability to each one of the communication terminals 20, and generates images to be transmitted to the communication terminal 20.

Further, the information transmission apparatus can be configured not to provide the interactive information processing capability of the information board image to the communication terminals 20, in which the information transmission apparatus generates the information board image to be transmitted to each one of the communication terminals 20. In this case, a software for implementing the common interactive information processing capability can be installed or downloaded to each one of the communication terminals 20 and the information transmission apparatus, and then the information transmission apparatus can provide the information board image to each one of the communication terminals 20.

As to the above described image processing apparatus, the image processing system, and the image processing method, the operation information performed at the each one of the electronic information terminals and transmitted to the image processing apparatus can be processed effectively at the image processing apparatus. Specifically, the first process can be executed without the effect of the second process, and thereby the desired process result can be attained. For example, the first process for processing the operation information performed at the each one of the electronic information terminals such as stroke drawing can be executed correctly by deactivating the second process such as switching of pages of the information board image when the first process is being executed.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions. Further, the above described image processing method performable in the image processing apparatus can be described as a computer-executable program, and the computer-executable program can be stored in a ROM or the like in the image processing apparatus image and executed by the image processing apparatus. Further, the computer-executable program can be stored in a storage medium or a carrier such as compact disc-read only memory (CD-ROM), digital versatile disc-read only memory (DVD-ROM) or the like for distribution, or can be stored on a storage on a network and downloaded as required.

Numerous additional modifications and variations for the communication terminal, information processing system, and information processing method, a program to execute the information processing method by a computer, and a storage or carrier medium of the program are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. An information transmission system comprising:
a plurality of communication terminals including at least a first terminal and a second terminal; and
an information transmission apparatus to receive operation information from the plurality of communication terminals via the network and to transmit image data corresponding to the received operation information to the plurality of communication terminals via a network;
wherein when the operation information is input from at least one of the communication terminals, the at least one of the communication terminal outputs the operation information and transmission allowing/not-allowing information set for each one of the plurality of communication terminals to the information transmission apparatus, the transmission allowing/not-allowing information including transmission allowing information or transmission not-allowing information indicating whether the operation information is to be transmitted to each one of the communication terminals, and
wherein the information transmission apparatus generates a transmission-use image to be transmitted to one or more of the communication terminals based on the operation information and the transmission allowing/not-allowing information that are output from the at least one of the communication terminals.

2. The information transmission system of claim 1, wherein the information transmission apparatus provides interactive information processing capability to each one of the plurality of communication terminals via the network to communicate information interactively with each one of the plurality of communication terminals.

3. The information transmission system of claim 1, wherein the information transmission apparatus generates the transmission-use image to be transmitted to one or more of the communication terminals when the operation information received from any one of the communication terminals is assigned with the transmission allowing information indicating to transmit the operation information to the one or more of the communication terminals.

4. The information transmission system of claim 1, wherein each one of the communication terminals includes circuitry that sets a value of the transmission allowing/not-allowing information.

5. The information transmission system of claim 4, wherein the circuitry changes the value of the transmission allowing/not-allowing information.

6. The information transmission system of claim 4, wherein at least one of the plurality of communication terminals sets reception allowing/not-allowing information for each one of the plurality of communication terminals, the reception allowing/not-allowing information including reception allowing information or reception not-allowing information indicating whether the operation information input from each one of the plurality of communication terminals is receivable by the at least one of the plurality of communication terminals, and
wherein when the at least one of the plurality of communication terminals outputs the reception allowing/not-allowing information to the information transmission apparatus, the information transmission apparatus generates the transmission-use image to be transmitted to at least one of the plurality of communication terminals based on the reception allowing/not-allowing information received from the at least one of the plurality of communication terminals.

7. The information transmission system of claim 6, wherein when the information transmission apparatus receives the transmission allowing/not-allowing information and the reception allowing/not-allowing information that do not match with each other, the information transmission apparatus sets a priority on the reception allowing/not-allowing information.

8. The information transmission system of claim 6, wherein the circuitry of each one of the communication terminals sets a value of the reception allowing/not-allowing information.

9. The information transmission system of claim 8, wherein the circuitry changes the value of the reception allowing/not-allowing information.

10. The information transmission system of claim 1, wherein when the transmission-use image to be transmitted to the first terminal and the transmission-use image to be transmitted to the second terminal becomes the same image, the information transmission apparatus generates the transmission-use image for one time, and transmits the generated transmission-use image to each of the first terminal and the second terminal.

11. The information transmission system of claim 4, wherein the information transmission apparatus includes a display that displays an image based on the operation information,
wherein the circuitry of each one of the communication terminals further sets additional transmission allowing/not-allowing information indicating whether the operation information is allowed to be transmitted to the display of the information transmission apparatus from each one of the communication terminals.

12. A method of transmitting information among a plurality of communication terminals via a network, the method comprising:
acquiring an operation information input from each one of the communication terminals and transmission allowing/not-allowing information set for each one of the communication terminals, the transmission allowing/not-allowing information including transmission allowing information or transmission not-allowing information indicating whether the operation information is to be transmitted to each one of the communication terminals;
generating image data to be transmitted to one or more of the communication terminals based on the acquired operation information and the transmission allowing information; and
transmitting the generated image data to the one or more of the communication terminals.

13. A non-transitory storage medium storing a program that, when executed by a computer, causes the computer to execute a method of transmitting information among a plurality of communication terminals via a network, the method comprising:
acquiring an operation information input from each one of the communication terminals and transmission allowing/not-allowing information set for each one of the communication terminals, the transmission allowing/not-allowing information including transmission allowing information or transmission not-allowing information indicating whether the operation information is to be transmitted to each one of the communication terminals;
generating image data to be transmitted to one or more of the communication terminals based on the acquired operation information and the transmission allowing information; and
transmitting the generated image data to the one or more of the communication terminals.
